(19) United States
(12) Patent Application Publication
(10) Pub. No.: US 2008/0284911 A1
(43) Pub. Date: Nov. 20, 2008

(54) Customized Advertising with Mhp Application

(75) Inventors: Johannes Hendrikus Maria Lemmers, Reek (NL); Michiel Josephus Christianen, Zundert (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,863

(22) PCT Filed: Oct. 27, 2006
(86) PCT No.: PCT/IB2006/053983

§ 371 Date: Apr. 28, 2008

Related U.S. Application Data
(60) Provisional application No. 60/730,974, filed on Oct. 28, 2005.

(51) Int. Cl. H04N 5/44

(52) U.S. Cl. 348/553; 348/E05.096

(57) ABSTRACT

A multimedia home platform (MHP) application (131) is customized for selecting, for presentation or recording during a commercial break (224), a channel or substream of a channel whose viewer category most closely matches the particular user profile (S320). The profile is built by logging channels visited, direct query and answer and by user voting on the commercial showing or just shown (S540).

The present invention relates to receiving advertisement in a television broadcast signal and, more particularly, to customizing the choice of advertisement according to the viewer's profile.

A current trend in television (TV) viewing is to introduce more interactivity into the experience. The use of remote control for digital television is a common form of interactivity. Video on demand (VoD), Internet access, personal video recording, interactive games and TV-based chat are among the modes gaining acceptance. It is also known to target advertising, so that those likely to watch a particular program on TV see commercials that fit the projected viewer profile. The profile may reflect the preferences of a majority of those anticipated to view the program.

There exists a need to introduce, into interactive television, advertising that more fully matches the preferences of the particular viewer.

To address the above-noted needs, the present invention, in one aspect, is directed to a television receiver, a method for receiving and computer program for carrying out the method. The receiver includes a receiving unit for receiving a broadcast that includes a plurality of streams. A processor interrupts, responsive to arrival at the receiving unit of advertising in the broadcast, display and/or recording of the broadcast to confine subsequent display and/or recording to a stream the processor has decided upon from among multiple alternatives.

In another aspect, a computer-readable broadcast signal for providing a processor with viewing alternatives includes a plurality of channels, at least one of which is divided into a plurality of substreams flowing in parallel. The signal contains advertising, at least part of which is contained in the plurality of substreams and has been pre-assigned, by substream, among different viewer categories according to an assignment included in the signal.

Details of the invention are set forth below with the aid of the following drawings, wherein:

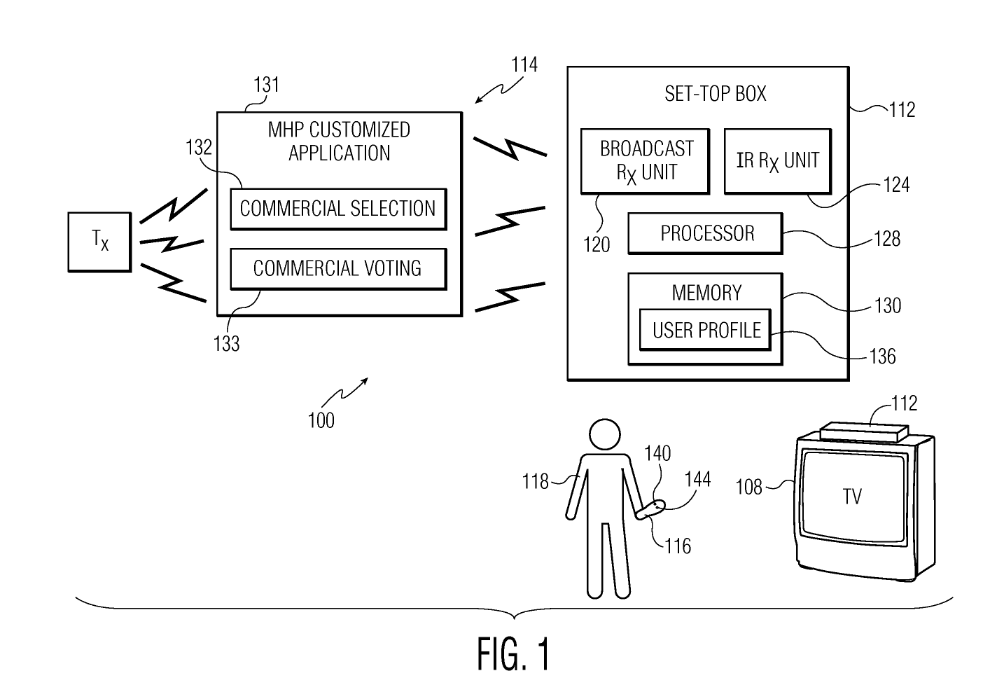

FIG. 1 is a conceptual diagram of a television system, the diagram including a block diagram of a television receiver;

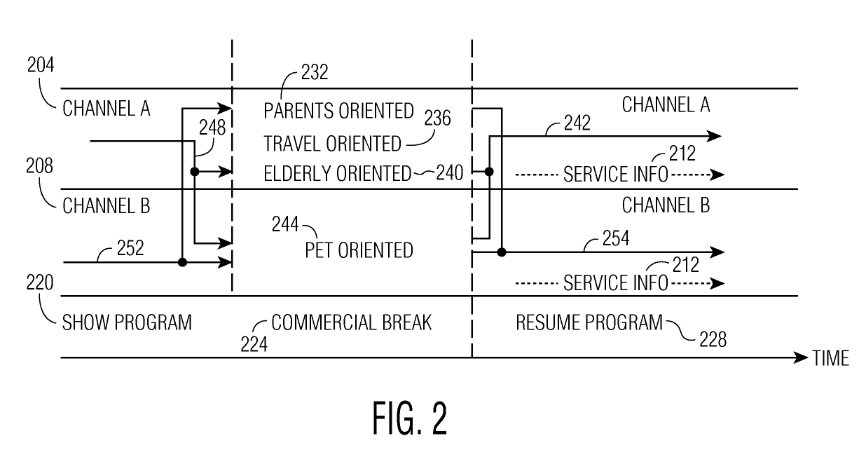

FIG. 2 is a timing chart on tuning before, during and after a commercial break;

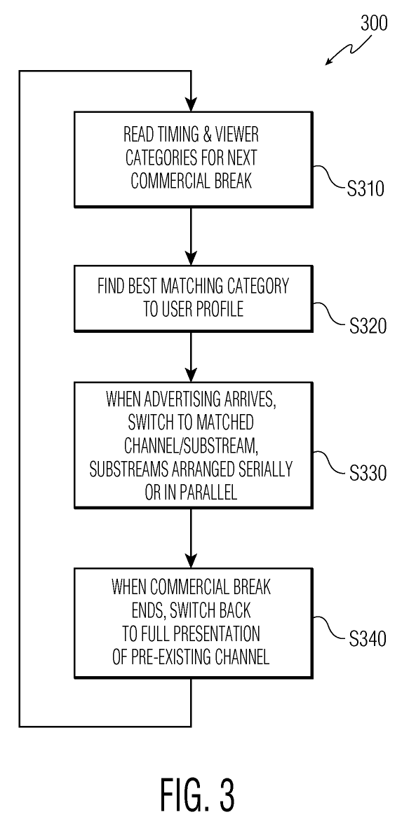

FIG. 3 is flow chart of an advertising selection process;

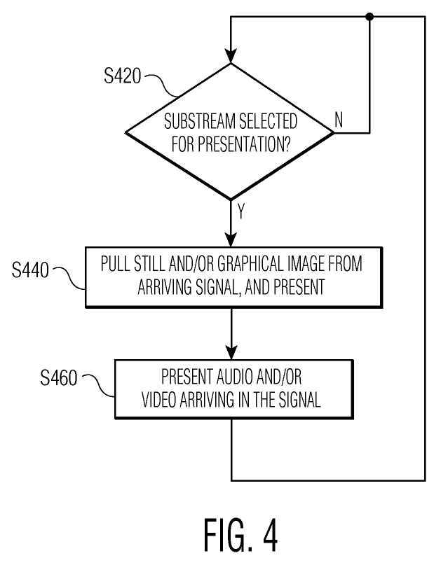

FIG. 4 is a flow chart of a process for showing a low-bandwidth commercial; and

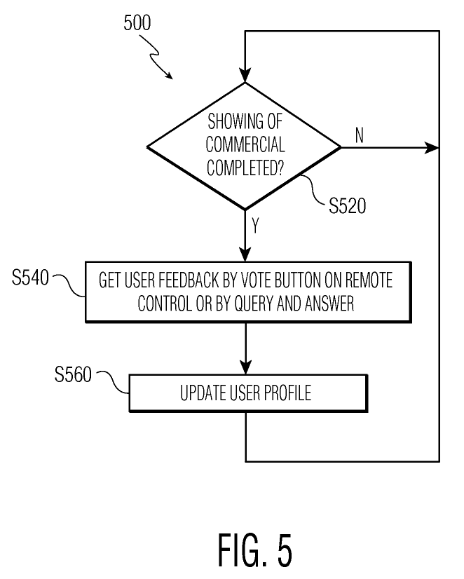

FIG. 5 is a flow chart of a viewer profile update process.

FIG. 1 depicts, according to the present invention, an exemplary television (TV) system 100 including a TV transmitter 104, a TV 108, a set-top box or receiver 112, a television broadcast signal 114, a remote control device 116 and a viewer or user 118 of the system.

The signal 114 carries, in addition to programming and advertising, a digital video broadcast (DVB) multimedia home platform (MHP) customized application 131. The application 131 includes a commercial selection module 132 for receiving a selected commercial, and a commercial voting module 133 by which the user 118 can vote approval or disapproval of a TV commercial showing or just shown.

The set-top box 112 includes a TV broadcast receiving unit 120, an infrared receiving unit or pickup device 124, a processor 128 and a memory 130. The set-top box 112 is made “MHP-compliant” or interoperable with application program interfaces (APIs) arriving in the TV broadcast 114. Other emerging standards such as OpenCable Application Platform (OCAP) may alternatively be utilized.

The processor 128 also includes a timer or clock (not shown) that keeps the current time. The processor 128 can, for comparison with the current time, check an assignment of scheduled TV commercials to respective viewer categories. The assignment is preferably provided in the TV broadcast signal 114 in accordance with the present invention, for example via MHP specific stream events inserted in the broadcast. Alternatively, the processor 128 can consult an electronic programming guide (EPG) or interactive program guide (IPG), which typically includes time schedules, provided that the EPG is enhanced with the viewer categories for commercials and with the below-described division of TV streams.

The storage memory 130 includes user profile storage 136 and preferably features permanent or non-volatile storage, as well as temporary or working storage. The latter typically would include random access memory (RAM). Permanent storage can take the form of read-only memory (ROM) of flash memory. Any variation of the above memory devices can be utilized.

The remote control device 116 has two voting buttons 140, 144, configurable from among those not already devoted to particular functions by MHP. Voting button 140 is actuated to indicate a favorable opinion of the commercial showing or just shown, and button 144 indicates the commercial was found unfavorable.

FIG. 2 represents, by way of illustrative and non-limitative example, how the receiver 112 selects advertising in the broadcast 114 for display on TV 108, and/or recording in the receiver provided commercials are recorded, according to the present invention.

According to MHP, the viewer or subscriber 118 receives a bouquet or “package” of channels or “services.” The bouquet may be distributed across different “multiplexes” or what MPEG calls transport streams. Each multiplex includes a plurality of elementary streams of different types, e.g., video, audio, data, and service information. The latter provides scheduling information for various categories of “events,” what MHP calls TV programs.

For simplicity of illustration, FIG. 2 shows merely two channels 204, 208, i.e., channels A and B, of a bouquet. Service information 212 is preferably carried in one or more elementary streams of each channel 204, 208.

A timeline 216 at the bottom of FIG. 2 traverses three periods of time. In the first period 220, a program is being broadcast. In the second period 224, commercials are shown, the commercial break preferably being concurrent for all channels 204, 208. At the conclusion 228 of the commercial break, regularly scheduled programming resumes.

Channel A 204 carries three different commercials, in respective substreams 232, 236, 240, during the commercial break 224. The three parallel-flowing substreams 232, 236, 240 carry advertising content of three respective categories, i.e., parents-oriented, travel-oriented and elderly-oriented. Channel B 208, by contrast, carries a single commercial 244, in the pet-oriented category. This category-based division into three streams 232, 236, 240 generally exists only during the commercial break 224.

Once the commercial break 224 begins, display and/or recording are potentially confined, to a different channel and/or to a substream of a channel. This is done in accordance with pre-selection based upon the categories of the commercials currently being broadcasted and upon the user profile 136. Knowledge of the categories is afforded by the service information 212, for example.

Tuning flow arrows 248 portray the case in which the TV 108 and/or set-top box 112 is currently tuned to channel A 204. Thus, commencement of the commercial break 224 confines presentation and/or recording to a pre-selected one 240 of the substreams 232, 236, 240 or, if another channel B 208 was pre-selected, to the commercial on that channel. Once programming resumes 228, full presentation of channel A 204 is re-established, as seen from tuning flow arrow 242. Although, in this example, the elderly-oriented commercial 240 is pre-selected for showing if the current channel is retained, either of the other two substreams 232, 236 could have been pre-selected instead. In addition, as discussed below, content of a non-selected substream may be utilized.

Tuning arrows 252 demonstrate an example of pre-selection in the event the viewer 118 is currently tuned to channel B 208. The exemplary pre-selection dictates that either the viewer remains tuned to channel B during the commercial break 224 or the current channel is switched to channel A 204. More particularly in the latter case, the parents-oriented substream 232 is used. When the program resumes 228, return is made to channel B 208, as seen from the tuning arrow 254.

The pre-selection is dependent upon a match between a profile of the user 118, which may be a composite profile of a plurality of individuals who have used the receiver 112, and predetermined viewer categories. Thus, in the present example, the processor 128 may have previously decided in favor of the “parents-oriented” category based on the user profile for the current viewer 118 and on the commercial-to-viewer category assignment arriving in the broadcast 114.

When the commercial break 224 ends, the program resumes 228.

Although all channels or substreams in the bouquet are shown in FIG. 2 as classified according to viewer category, the commercials of some channels may not be classified. Accordingly, the broadcasted signal 114 can be made backward-compatible with non-customized receivers, which can, for example, have their bouquets not include channels divided into categorized substreams. For extra variety of commercial choice, the customized receiver can be configured with a bi-directional return channel outside the DVB network.

FIG. 3 shows one example of a process 300 for receiving selected advertising, in accordance with the present invention. Before commencement of the commercial break 224, the time of the next commercial break and the viewer categories of commercials in the bouquet are looked up in the service information 212 included in the broadcast signal 114 (step S310). This information may alternatively arrive as a dedicated trigger in the broadcast stream. User profile information in the user profile storage 136 is compared to each of the looked up viewer categories to find a best match (step S320). The channel and/or substream for the best-matching category is retained or switched to, once the commercial break 228 begins (step S330). If the commercial break 224 entails more than one commercial, then a selection among channels/substreams has been made for each commercial. At the conclusion of the commercial break 224, return is made to the unconfined display and/or recording that existed before interruption by the commercial break. Thus, the program resumes in the same channel (step S340).

Television commercials typically include video, at about 5 megabits per second. If each channel is allocated the same amount of bandwidth, e.g., 5 megabits/second, the video in substreams may be “thinned” so that each substream comes within a limit of 1.67 megabits/second. This can be accomplished by removing dynamic content from each stream. For example, a reduction can be made in the number B-frames in the Motion Pictures Experts Group (MPEG) protocol.

In a preferred technique, reduction is realized by preparing the video to deliver still images temporally over portions of the commercial and/or spatially over portions of the TV screen. In one embodiment, the processor 128 may be configured to pull a still image from a non-selected substream of a selected channel to provide temporal or spatial cover. As an example of how this can be done temporally, a bank advertisement may be divided into four video substreams, i.e., for stock investments, mortgage, student bank account and travel insurance, arranged to run serially, end-to-end, during the commercial. Stills, such as graphical images with the advertising message, may be added by the broadcaster to the substreams so that the substream selected, or one not selected, provides a still picture for showing during its respective temporal slot. Thus, the still pulled need not reflect the substream that delivered it. Instead, each substream can carry stills for the other three, so that the selected substream fully reflects material that has been placed in the selected viewer category. Accordingly, if the stock investments substream is selected, its temporal segment is played, and, for the rest of the time, the commercial shows stills relating to the bank's stock investment service. The application 131 can generate the still image for presentation based on image data the application pulls from a stream or substream, or can generate the still from image data previously provided, as by download. The still image, e.g., overlay graphic, is optionally extended with audio and/or scaled video arriving in the elementary stream(s) of the substream selected for presentation or in non-selected substreams. As an alternative to a strictly still image, moving graphics may be utilized, as in the case of internet-like flash animation.

FIG. 4 illustrates an example of processing during the commercial break 224 when a substream is pre-selected, in accordance with the present invention. If a substream is pre-selected for an upcoming commercial break 224 (step S420), a still and/or graphical image whose advertising message relates to the category of the pre-selected substream may be pulled from the arriving signal 114 and be shown on-screen (step S440). Other audio and/or video which preferably has been scaled can also be obtained from the arriving signal 114 and presented during the commercial (step S460). During this time, the still/graphical image may be retained on-screen.

FIG. 5 is a conceptual flow chart providing an exemplary process 500 for maintaining the user profile, in accordance with the present invention. When the showing or recording of a commercial ends, or during the showing (step S520), user feedback is preferably collected by the processor 128 (step S540).

In one embodiment, keys or buttons 140, 144 are actuated by the user in voting for or against the commercial. This develops the user profile.

In another embodiment, the processor 128 can question the user 118 on-screen on the TV 108. The user 118 can use the remote control 116 to provide answers, as by navigating a menu on the remote control. Alternatively, buttons or keys on the set-top box 104 can be operated.

If the user 118 shows interest in a particular product or service being advertised, such as by ordering the product, or asking further questions, this is noted in updating the user profile (step S560).

More generally, as an alternative method or an adjunct to either of the above two, the processor can track the user's viewing behavior, such as by logging the channels watched, to maintain the user profile. DVB broadcasts provide a mechanism by which to distribute banner and EPG information about the present and future broadcasted programs, including a program category. With this information, the application 131 is able to improve the user profile by adapting the profile to reflect preferred program categories. Thus, when a viewer often watches children programs, the system might decide to present child- or parent-oriented advertisements.

The input and feedback from the viewer 118 which is gathered by the processor 128 can be sent back to the advertiser, who can then determine the number of viewers and TV ratings. In addition, the impact and efficiency of TV advertising can be improved.

The application 131 is preferable downloaded automatically in the broadcast 114, thereby simplifying update of the application and the user's enrollment. Moreover, any MHP-compliant receiver 112 can be used, without the need for adjustment.

While there have been shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it should be recognized that structures and/or elements and/or method steps shown and/or described in connection with any disclosed form or embodiment of the invention may be incorporated in any other disclosed or described or suggested form or embodiment as a general matter of design choice.

1. A television receiver comprising:
a receiving unit (112) for receiving a broadcast that includes a plurality of streams (248, 252); and
a processor (128) configured for, responsive to arrival at the receiving unit of advertising in the broadcast, interrupting display and/or recording of said broadcast to confine subsequent display and/or recording of said broadcast to a stream of the plural streams that said processor has decided upon from among multiple alternatives (S330, S340).

2. The receiver of claim 1, wherein the interrupted display and/or recording is of a current television channel (248), and wherein an alternative of said alternatives is to switch from said current television channel to another television channel (244).

3. The receiver of claim 2, wherein a sub-alternative of said alternative is to confine said subsequent display and/or recording to fewer than all of a plurality of substreams of said another television channel (232), said substreams flowing in parallel and being assigned to different respective viewer categories.

4. The receiver of claim 1, wherein the interrupted display and/or recording is of a current television channel (248), and wherein a first of said alternatives is to confine said subsequent display and/or recording to fewer than all of a plurality of substreams of said current television channel (240), said substreams flowing in parallel and being assigned to different respective viewer categories.

5. The receiver of claim 4, wherein said broadcast carries a plurality of television channels, including said current television channel, each being assigned the same amount of bandwidth, a second of said alternatives being to switch to another television channel not divided into substreams assigned respectively to different viewer categories (244).

6. The receiver of claim 1, wherein the interrupted display and/or recording is of a current television channel (248), and wherein a first of said alternatives is to confine said subsequent display and/or recording to fewer than all of a plurality of substreams of said current television channel (240), said substreams flowing in series during a commercial break and being assigned to different respective viewer categories.

7. The receiver of claim 1 configured to return to unconfined display and/or recording that existed before said interrupting, once said subsequent display and/or recording of the arriving advertising has completed (S340).

8. The receiver of claim 1, wherein said processor is configured for gathering viewing behavior in connection with use of said receiver (S540), said processor thereby maintaining a user profile (S560), the deciding being dependent upon said profile.

9. The receiver of claim 8, wherein said gathering includes detecting actuation of one of two user feedback controls whose actuation votes on said advertising (S540).

10. The receiver of claim 8, wherein said gathering includes detecting feedback a user provides in response to a query made by said processor (S540).

11. A computer-implemented method for receiving a television broadcast that includes a plurality of streams (232, 236, 240, 244), comprising:
deciding, by a processor and from among multiple alternatives, upon a stream of plural streams carried in said broadcast (S320); and,
responsive to arrival of advertising in said broadcast, interrupting display and/or recording of said broadcast to confine subsequent display and/or recording of said broadcast to the stream decided upon (S340).

12. The method of claim 11, wherein the interrupted display and/or recording is of a current television channel (252), said stream decided upon being another television channel (232).

13. The method of claim 11, wherein the interrupted display and/or recording is of a current television channel (252), said stream decided upon including fewer than all of a plurality of substreams of another television channel (232), said substreams flowing in parallel and being assigned to different respective viewer categories.

14. The method of claim 11, wherein the interrupted display and/or recording is of a current television channel (248), said stream decided upon being f ewer than all of a plurality of substreams of said current television channel (240), said substreams flowing in parallel and being assigned to different respective viewer categories.

15. The method of claim 14, wherein said broadcast carries a plurality of television channels, including said current television channel, each being assigned the same amount of bandwidth, a second of said alternatives being to switch to another television channel not divided into substreams assigned respectively to different viewer categories (248, 244).

16. The method of claim 11, further comprising returning to unconfined display and/or recording that existed before said interrupting, once said subsequent display and/or recording of the arriving advertising has completed (S340).

17. The method of claim 11, further comprising gathering, to maintain a user profile, viewing behavior in connection with use of said receiver (S540), said deciding being dependent upon said profile.

18. The method of claim 17, wherein said gathering includes detecting actuation of one of two user feedback controls whose actuation votes on said advertising (S540).

19. A computer program product comprising a computer-readable medium (130) embedded into which is a program comprising instructions executable by said processor to perform the method of claim 11.

20. A computer-readable broadcast signal (114) for providing a processor with viewing alternatives (S330), said signal including a plurality of channels, at least one of which is divided into a plurality of substreams flowing in parallel, said signal containing advertising, at least part of which is contained in said plurality of substreams and has been pre-assigned, by substream, among different viewer categories according to an assignment included in said signal.

21. A transmitter (104) configured to form said signal of claim 20.

22. The signal of claim 20, comprising an application (131) executable, by said processor based on said assignment, to decide among the plural channels and the plural substreams in presenting and/or recording said advertising.

23. The signal of claim 22, wherein the deciding is further based on a user profile (136) that is maintained by said processor based on viewing behavior in connection with use of a receiver of said signal.

24. The signal of claim 22, wherein said application is configured for generating an image that is at least one of still and graphical (S440), for presentation if a substream of the plural substreams is decided upon by said processor.

25. The signal of claim 24, wherein said application is configured for, concurrent with said presentation, presenting at least one of audio and video, said audio and video arriving in said signal (S460).
